(19) United States
(12) Patent Application Publication
(10) Pub. No.: US 2016/0185285 A1
(43) Pub. Date: Jun. 30, 2016

(54) COLLISION ALARM ASSEMBLY

(71) Applicant: Adam Lawlor, Sr., Clinton Corners, NY (US)

(72) Inventor: Adam Lawlor, Sr., Clinton Corners, NY (US)

(21) Appl. No.: 14/587,252

(22) Filed: Dec. 31, 2014

(51) Int. Cl. B60Q 1/52; G08G 1/0967; G08G 1/16; B60Q 5/00

(52) U.S. Cl. CPC B60Q 1/52; B60Q 5/006; G08G 1/096741; G08G 1/162

(57) ABSTRACT

A collision alarm assembly includes a housing coupled to a vehicle. A light emitter is coupled to the housing. A control is coupled to the vehicle. A processor is coupled to the control. The processor is electrically coupled to the light emitter, actuating the light emitter to repeatedly flash. A sensor is coupled to the vehicle to detect when an airbag has been deployed in the vehicle. The sensor is electrically coupled to the processor to actuates the light emitter when the airbag is deployed. The light emitter alerts an observer that the airbag has been deployed.

### BACKGROUND OF THE DISCLOSURE

1. Field of the Disclosure

The disclosure relates to alarm devices and more particularly pertains to a new alarm device for alerting an observer that a vehicle airbag has been deployed.

2. Summary of the Disclosure

An embodiment of the disclosure meets the needs presented above by generally comprising a housing coupled to a vehicle. A light emitter is coupled to the housing. A control is coupled to the vehicle. A processor is coupled to the control. The processor is electrically coupled to the light emitter, actuating the light emitter to repeatedly flash. A sensor is coupled to the vehicle to detect when an airbag has been deployed in the vehicle. The sensor is electrically coupled to the processor to actuates the light emitter when the airbag is deployed. The light emitter alerts an observer that the airbag has been deployed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a collision alarm assembly according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is a top view of an embodiment of the disclosure.

### DESCRIPTION OF THE PREFERRED EMBODIMENT

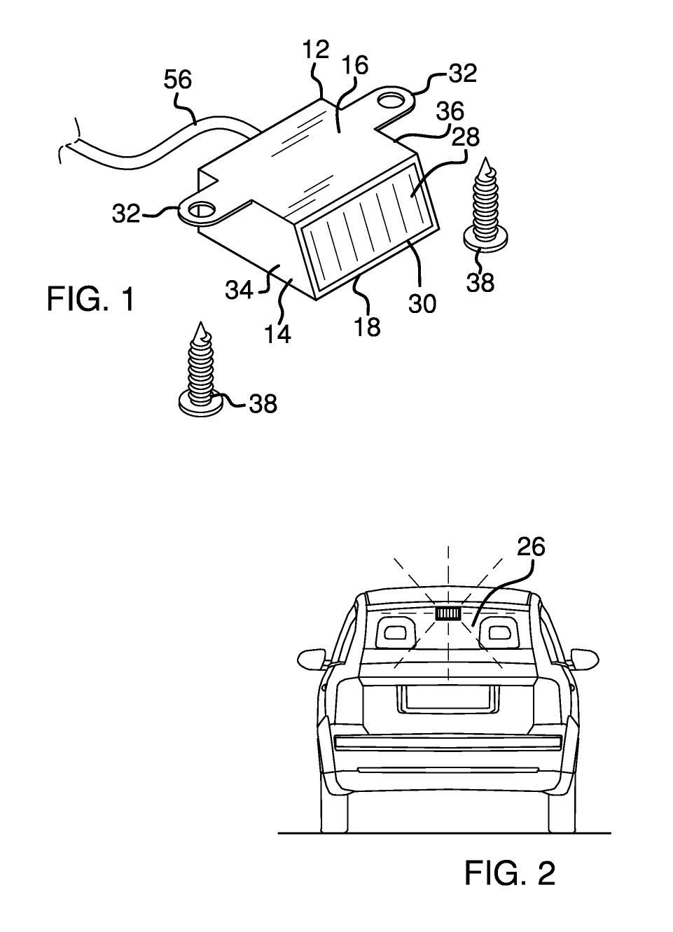

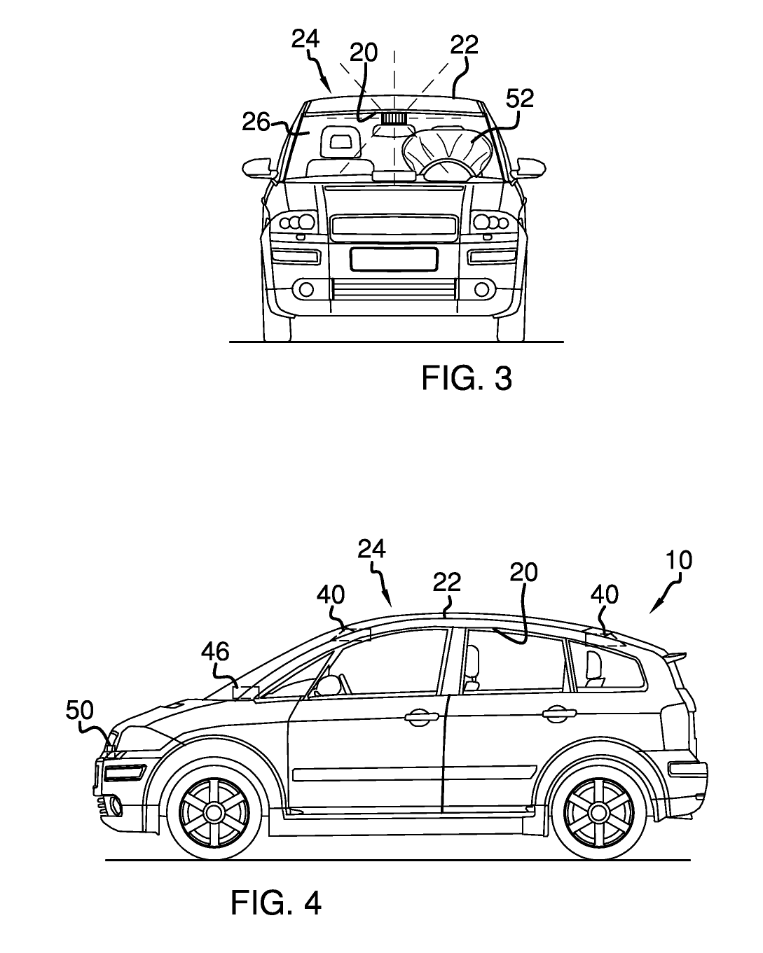

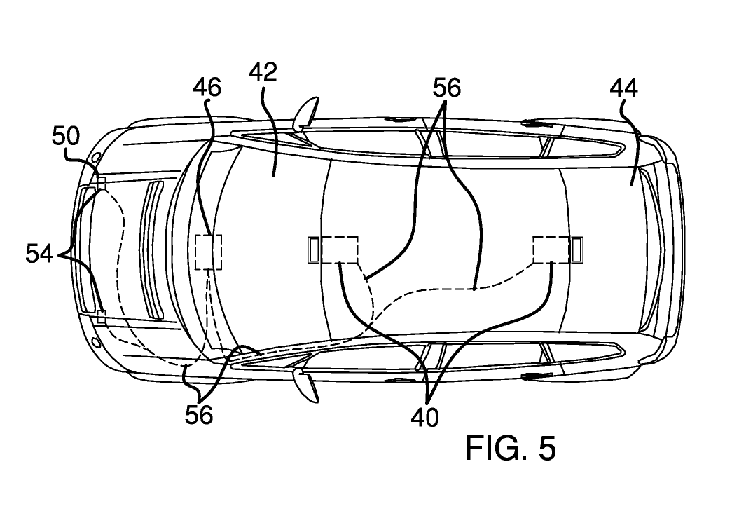

With reference now to the drawings, and in particular to FIGS. 1 through 5 thereof, a new alarm device embodying the principles and concepts of an embodiment of the disclosure and generally designated by the reference numeral 10 will be described.

As best illustrated in FIGS. 1 through 5, the collision alarm assembly 10 generally comprises a housing 12. The housing 12 comprises an outer wall 14 extending between each of a top wall 16 and a bottom wall 18. The top wall 16 is coupled to a bottom side 20 of a roof 22 of a vehicle 24 such that the housing 12 is visible through a window 26 of the vehicle 24. The vehicle 24 may be a passenger vehicle or the like.

A light emitter 28 is coupled to a back side 30 of the outer wall 14 to be visible through the window 26. The light emitter 28 may be an LED or the like. Each of a pair of tabs 32 is coupled to and extends laterally away from an associated one of a first lateral side 34 and a second lateral side 36 of the outer wall 14. Each of the tabs 32 is positioned adjacent to the top wall 16. A pair of fasteners 38 extends through an associated one of the tabs 32 and engages the bottom side 20 of the roof 22, retaining the housing 12 on the roof 22.

The housing 12 is one of a pair of the housings 40. Each of the housings 40 is positioned proximate to and is visible through an associated one of a front windshield 42 and a rear window 44 of the vehicle 24. A control 46 is coupled to the vehicle 24. A processor 48 is coupled to the control 46. The processor 48 is electrically coupled to the light emitter 28. The processor 48 actuates the light emitter 28 to repeatedly flash.

A sensor 50 is coupled to the vehicle 24 o detect when an airbag 52 has been deployed in the vehicle 24. The sensor 50 is electrically coupled to the processor 48 to actuate the light emitter 28 when the airbag 52 is deployed. The light emitter 28 alerts an observer that the airbag 52 has been deployed. The observer may be an emergency responder or the like. The sensor 50 is one of a pair of the sensors 54 each electrically coupled to an associated one of a pair of the airbags 52. A plurality of conductors 56 is provided. Each of the conductors 56 is electrically coupled between a respective one of the housings 40 and the control 46 and between the control 46 and a respective one of the sensors 54.

In use, the control 46 is used to reset the pair of sensors 54 and the light emitters 28 after the airbags 52 have deployed. The assembly 10 identifies the vehicle 24 as having been involved in an accident. Additionally, the assembly 10 allows the vehicle 24 to be found in a dark environment when the vehicle 24 has been involved in an accident.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collision alarm assembly comprising:
a housing configured to be coupled to a vehicle;
a light emitter coupled to said housing;
a control configured to be coupled to the vehicle;
a processor coupled to said control, said processor being electrically coupled to said light emitter wherein said processor actuates said light emitter to repeatedly flash; and
a sensor configured to be coupled to the vehicle wherein said sensor is configured to detect when an airbag has been deployed in the vehicle, said sensor being electrically coupled to said processor wherein said processor actuates said light emitter when the airbag is deployed wherein said light emitter is configured to alert an observer that the airbag has been deployed.

2. The assembly according to claim 1, wherein said housing comprises an outer wall extending between each of a top wall and a bottom wall, said top wall being coupled to a bottom side of a roof of the vehicle such that said housing is visible through a window of the vehicle, said light emitter being coupled to a back side of said outer wall wherein said light emitter is visible through the window of the vehicle.

3. The assembly according to claim 2, further comprising a pair of tabs, each of said tabs being coupled to and extending laterally away from an associated one of a first lateral side and a second lateral side of said outer wall, each of said tabs being positioned adjacent to said top wall, a pair of fasteners extending through an associated one of said tabs and engaging the bottom side of the roof wherein said housing is retained on the roof.

4. The assembly according to claim 3, wherein said housing being one of a pair of said housings, each of said housings being positioned proximate to and being visible through an associated one of a front windshield and a rear window of the vehicle.

5. The assembly according to claim 4, wherein said sensor being one of a pair of said sensors each electrically coupled to an associated one of a pair of airbags.

6. The assembly according to claim 5, further comprising a plurality of conductors, each of said conductors being electrically coupled between a respective one of said housings and said control and between said control and a respective one of said sensors.

7. A collision alarm assembly comprising:
a housing, said housing comprises an outer wall extending between each of a top wall and a bottom wall, said top wall being coupled to a bottom side of a roof of the vehicle such that said housing is visible through a window of the vehicle;
a light emitter, said light emitter being coupled to a back side of said outer wall wherein said light emitter is visible through the window of the vehicle;
a pair of tabs, each of said tabs being coupled to and extending laterally away from an associated one of a first lateral side and a second lateral side of said outer wall, each of said tabs being positioned adjacent to said top wall, a pair of fasteners extending through an associated one of said tabs and engaging the bottom side of the roof wherein said housing is retained on the roof;
said housing being one of a pair of said housings, each of said housings being positioned proximate to and being visible through an associated one of a front windshield and a rear window of the vehicle;
a control configured to be coupled to the vehicle;
a processor coupled to said control, said processor being electrically coupled to said light emitter wherein said processor actuates said light emitter to repeatedly flash;
a sensor configured to be coupled to the vehicle wherein said sensor is configured to detect when an airbag has been deployed in the vehicle, said sensor being electrically coupled to said processor wherein said processor actuates said light emitter when the airbag is deployed wherein said light emitter is configured to alert an observer that the airbag has been deployed, said sensor being one of a pair of said sensors each electrically coupled to an associated one of a pair of the airbags; and
a plurality of conductors, each of said conductors being electrically coupled between a respective one of said housings and said control and between said control and a respective one of said sensors.
